(19) United States
(12) Patent Application Publication
(10) Pub. No.: US 2008/0289884 A1
(43) Pub. Date: Nov. 27, 2008

(54) Touch-Based Input Device with Boundary Defining a Void

(76) Inventor: James K. Elwell, Salt Lake City, UT (US)

Correspondence Address: THORPE NORTH & WESTERN, LLP., P.O. Box 1219, SANDY, UT, 84091-1219, US

(21) Appl. No.: 12/125,848

(22) Filed: May 22, 2008

Related U.S. Application Data
(60) Provisional application No. 60/931,400, filed on May 22, 2007.

(51) Int. Cl. G06K 11/06

(52) U.S. Cl. 178/18.01

(57) ABSTRACT

A touch-based input device comprising a first structural element supported in a fixed position, a second structural element operable with said first structural element and configured to define a touch-sensing element. The touch-based input device further comprising at least one sensor operable to measure an external stimulus applied to said touch-sensing element, the at least one sensor being configured to output a signal corresponding to said external stimulus to be used to determine a location of said external stimulus applied to said touch-sensing element, wherein at least a portion of the touch-sensing element comprises a boundary defining a void present in the touch-sensing element.

### PRIORITY CLAIM

This application claims the benefit of U.S. Provisional Application No. 60/931,400 filed on May 22, 2007 entitled “User Interfaces and Utilities Operable with a Force-Based Input Device” the entirety of which is incorporated herein by reference.

### FIELD OF THE INVENTION

The present invention relates to input devices, touch panels, computer displays and the like, and more particularly to the various user interfaces, namely physical interfaces, utilities, attachments, etc. that may be operable with and/or supported about these.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, point of sale terminals, vending machines, medical devices, keypads, keyboards, and others.

Currently, there are a variety of different types of input devices available on the market. Some examples include resistive-based input devices, capacitance-based input devices, surface acoustic wave-based devices, force-based input devices, infrared-based devices, and others. While each provides some useful functional aspects, each of these prior related types of input devices suffers in one or more areas.

Resistive-based input devices typically comprise two conductive plates that are required to be pressed together until contact is made between them. Resistive sensors only allow transmission of about 75% of the light from the input pad, thereby preventing their application in detailed graphic applications. In addition, the front layer of such devices is typically comprised of a soft material, such as polyester, that can be easily damaged by hard or sharp objects, such as car keys, pens, etc. As such, this makes them inappropriate for most public-access applications.

Capacitance-based input devices operate by measuring the capacitance of the object applying the force to ground, or by measuring the alteration of the transcapacitance between different sensors. Although inexpensive to manufacture, capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Infrared-based devices are operated by infrared radiation emitted about the surface of the input pad of the device. However, these are sensitive to debris, such as dirt, that affect their accuracy.

Each of these types of input devices also suffers from their inability to provide different utilities and interfaces other than simply a touch surface that might have various graphics or other indicia thereon. As such, these input devices tend to be very generic in both their function and appearance.

### SUMMARY OF THE INVENTION

In light of the problems and deficiencies inherent in the prior art, the present invention seeks to overcome these by providing a void present within a portion of a touch-sensing element of a touch-based input device, which void may be present purely for aesthetic purposes, capable of operably working with one or more add-on interfaces or utilities, referred to herein as functional attachments, or both. In one aspect, said functional attachments provide the input device with improved user interfaces and functionality, such as added features, capabilities and/or aesthetics.

Generally speaking, in accordance with one embodiment of the present invention, a touch-based input device is disclosed comprising a first structural element supported in a fixed position, a second structural element operable with said first structural element and configured to define a touch-sensing element, and at least one sensor operable to measure an external stimulus applied to said touch-sensing element, the at least one sensor being configured to output a signal corresponding to said external stimulus to be used to determine a location and/or magnitude of said external stimulus applied to said touch-sensing element. The touch-based input device further comprises a boundary defining one or more voids present in the touch-sensing element. In one aspect, the void extends through the entire touch-sensing element, however, it is not necessary for all applications of the invention.

According to one embodiment of the present invention, the touch-based input device further comprises a functional attachment mounted to a surface of the touch-sensing element. The functional attachment may be mounted to a surface of the touch-sensing element such that a force exerted on the functional attachment displaces the touch-sensing element. Such displacement may activate components of the functional attachment. In one aspect, the functional attachment is removably supported within said void and/or is interchangeable with another functional attachment. As noted herein, the void may be positioned with respect to a functional attachment to enable user interaction with the functional attachment. Examples of user interaction include, but are not limited to, passage of an object to and/or from the functional attachment, such as insertion of a credit card or DVD and or receipt of money or other media. The voids can also be configured to transmit wave energy including sound, electromagnetic radiation, and any combination of these through the touch sensing element.

In accordance with one invention as embodied and broadly described herein, the present invention resides in a force-based input device comprising a first structural element supported in a fixed position; a second structural element operable with said first structural element, and dynamically supported to be movable with respect to said first structural element to define a force-sensing element configured to displace under an applied force; a plurality of isolated beam segments joining said first and second structural elements, said isolated beam segments being operable to transfer forces between the first and second structural elements resulting from displacement of said force-sensing element; at least one sensor operable to measure strain within each of said isolated beam segments resulting from said transfer of forces and said displacement of said force-sensing element, each of said sensors being configured to output a signal, corresponding to said applied force and said measured strain, to be used to determine a location of said applied force on said force-sensing element; at least one void present within the force-sensing element; and a functional attachment disposed within the at least one void.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a force-based sensing device in accordance with one exemplary embodiment of the present invention;

FIG. 2 illustrates a perspective view of the force-based sensing device of FIG. 1 as coupled to a processing system used to perform the necessary processing steps to determine the location of the applied force;

FIG. 3a illustrates a top view of a force-based input device having an LCD display operable with a force-sensing element, in accordance with one exemplary embodiment of the present invention;

FIG. 3b illustrates a side view of the force-based input device of 3a.

FIG. 4a illustrates a top view of a force-based input device having a plurality of voids present therein operable with a speaker mounted on a rear side of the force-based input device, in accordance with one exemplary embodiment of the present invention;

FIG. 4b illustrates a side view of the force-based input device of 4a;

FIG. 5a illustrates a top view of a force-based input device having a multi-layered functional attachment operable with a force-sensing element, in accordance with one exemplary embodiment of the present invention;

FIG. 5b illustrates a side view of the force-based input device of 5a;

FIG. 6a illustrates a top view of a force-based input device having a card reader operable disposed within a void present in the force-based input device, in accordance with one embodiment of the present invention;

FIG. 6b illustrates a side view of the force-based input device of FIG. 6a;

FIG. 7a illustrates a top view of a device configured to receive and/or dispense money disposed within a void present in the force-based input device, in accordance with one embodiment of the present invention;

FIG. 7b illustrates a side view of the force-based input device of FIG. 7a;

FIG. 8a illustrates a top view of a force-based input device having a media player mounted on a rear surface of the force-based input device, in accordance with one embodiment of the present invention;

FIG. 8b illustrates a side view of the force-based input device of FIG. 8a;

FIG. 9a illustrates a top view of a force-based input device with a printer device mounted on a rear surface of the force-based input device in accordance with one embodiment of the present invention;

FIG. 9b illustrates a side view of the force-based input device of FIG. 9a;

FIG. 10a illustrates a top view of a force-based input device with a button disposed within a void present in the force-based input device in accordance with one embodiment of the present invention;

FIG. 10b illustrates a side view of the force-based input device of FIG. 10a;

FIG. 11a illustrates a top view of a force-based input device with a dial assembly disposed within a void present in the force-based input device in accordance with one embodiment of the present invention;

FIG. 11b illustrates a side view of the force-based input device of FIG. 11a.

FIG. 12a illustrates a top view of a force-based input device with a slot machine display disposed within a void present in the force-based input device in accordance with one embodiment of the present invention;

FIG. 12b illustrates a side view of the force-based input device of FIG. 12a;

FIG. 12c illustrates a side view of an alternative of the force-based input device of FIG. 12a.

FIG. 13a illustrates a side view of a void present within a force-based input device in accordance with one embodiment of the present invention;

FIG. 13b illustrates a side view of a void present within a force-based input device in accordance with one embodiment of the present invention;

FIG. 13c illustrates a side view of a void present within a force-based input device in accordance with one embodiment of the present invention;

FIG. 13d illustrates a side view of a void present within a force-based input device in accordance with one embodiment of the present invention;

FIG. 13e illustrates a side view of a void present within a force-based input device in accordance with one embodiment of the present invention;

FIG. 13f illustrates a side view of a void present within a force-based input device in accordance with one embodiment of the present invention;

FIG. 14a illustrates a top view of a plurality of voids present within a force-based input device in accordance with one embodiment of the present invention;

FIG. 14b illustrates a top view of a plurality of voids present within a force-based input device in accordance with one embodiment of the present invention;

FIG. 14c illustrates a top view of a void present within a force-based input device in accordance with one embodiment of the present invention;

FIG. 15a illustrates a cut-away side view of a force-based input device having a three-dimensional surface in accordance with one embodiment of the present invention; and

FIG. 15b illustrates a cut-away side view of a force-based input device having a three-dimensional surface in accordance with one embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a force-based input device having one or more voids present within a touch-sensing element (touch receiving component and multiple force sensing elements). As used herein, the term “void” includes a gap or opening within the touch-sensing element; terms such as holes, cut outs, and apertures used herein are interchangeably used with the term void. In one aspect, functional attachments are disposed within the void in the input device. The functional attachments are designed and intended to expand the functionality of the force-based input device, as well as to introduce and provide new and exciting interfaces that are operable with the touch-sensing element of the input device.

As used herein, the term “functional attachment” includes any device or object capable of providing an aesthetic function, a utility function, a tactile function, or a combination of any of these and others. Indeed, rather than simply providing a planar, rigid touch surface as found in prior related input devices, particularly those that are not of the force-based type, the present invention introduces and creates user interfaces not in use with other input devices. The concept of incorporating a wide variety of “attachments” is, in general, one of the unique features of the present invention touch-based input device.

With general reference to force-sensing input devices and force-sensing elements, one example of a functional attachment according to one aspect of the invention broadly includes features that are not sensed by the force-sensing element. In this case, the functional attachment provides one or more functions not intended to apply a registered force. Generally speaking, a functional attachment can be attached or mounted to either side of a force-sensing element or a projected panel using any suitable means. The ability to have penetrations, discussed in more detail below, allows something as simple as a clear through hole with a bolt and nut. Functional attachments, including projected functional attachments or panels, can also be removably coupled, or coupled with temporary means, allowing for simple and quick relocation or replacement. According to an additional embodiment of the present invention, a functional attachment is disposed on a rear side of the force-sensing element of the input device and is configured to receive objects which are delivered through the void present in the touch-sensing element. In addition, in the event the input device, or rather the force-sensing element, is opaque or not necessarily transparent, the void may function to permit or improve visibility through the force-sensing element.

The present invention provides several significant advantages over prior related input devices and the user interfaces operable with these. Many advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

### Input Device

The present invention voids are intended to be operable with input devices, and particularly with force-based input devices. While specific reference is made herein to a particular configuration of a force-based input device, it is understood that any touch-based input device is contemplated for use herein comprising a touch-sensing element which generates a signal in response to a touch from an external stimulus. Examples of such touch-based input devices include, but are not limited to, resistive-based input devices, capacitance-based input devices, surface acoustic wave-based devices, force-based input devices, and infrared-based devices.

In one aspect of the invention, a force-based input device comprises a first, mounted or stationary structural support member, and a second, dynamic structural support member that moves or displaces with respect to the first structural support member, wherein the second, dynamic structural support member comprises a force-sensing element designed to receive and register forces applied to its surface, either directly or indirectly. Direct application of force would mean that the force is acting directly on the surface of the force-sensing element. Indirect application of force would mean that the force is acting on another object or surface, but that the applied force is sufficiently transferred to the force-sensing element to cause the force to register as if it were applied directly to the force-sensing element itself. For instance, in the case of a functional attachment that is sensed by the force-sensing element, the force-based input device is capable of registering and determining a location of a force that is applied on the functional attachment. The force acting on the functional attachment, and that is transferred to the force-sensing element, registers the same or substantially the same coordinates as if the force were being applied directly to the force-sensing element. This is made possible by the configuration of the force-based input device being used.

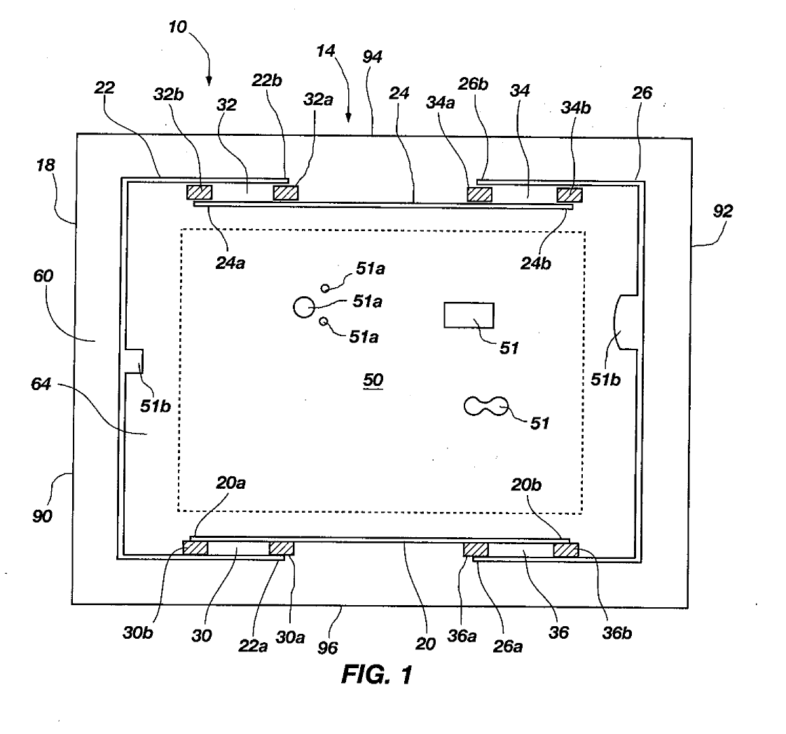

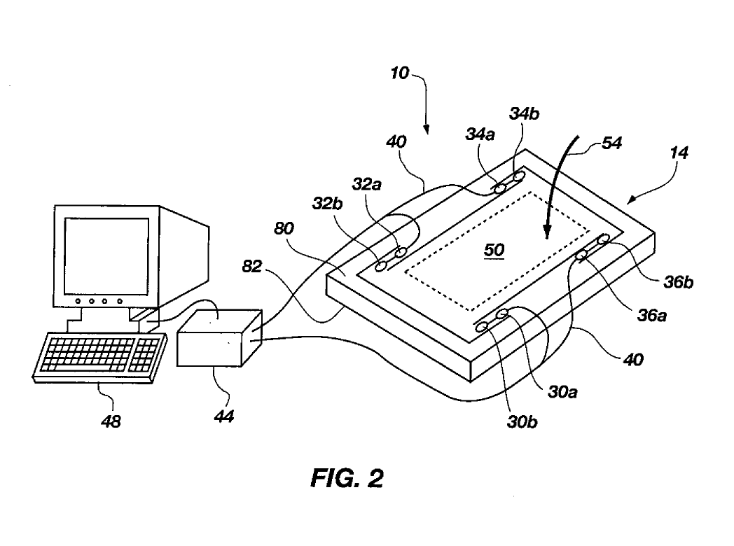

Within the force-based input device, the force-sensing element may comprise many different types and configurations. For example, the force-sensing element may comprise any of those described in U.S. application Ser. No. 11/402,694, filed Apr. 11, 2006, and entitled, “Force-based Input Device;” U.S. application Ser. No. 12/002,334, filed Dec. 14, 2007 and entitled “Force-based Input Device Having a Modular Sensing Component;” and U.S. application Ser. No. 11/888,673, filed Jul. 31, 2007, and entitled, “Force-Based Input Device Having an Elevated Contacting Surface,” each of which are incorporated by reference in their entirety herein. In one exemplary embodiment, with reference to FIGS. 1 and 2, shown is a force-based input device 10. The input device 10 can have a first structural member in the form of a base support 14 having an outer periphery 18. A plurality of apertures 20, 22, 24, and 26 can be formed in the base support 14 within the periphery 18. The apertures 20, 22, 24, and 26 can be located along the periphery 18 and can circumscribe or define a second structural member in the form of an input pad or force-sensing element 50 that is movable with respect to the first structural member or base support 14 in response to an applied load.

The plurality of apertures can also define a plurality of isolated beam segments, 30, 32, 34, and 36, near the corners of, and parallel to the sides of the force-sensing element 50. Two sensors (see sensors 30a, 30b, 32a, 32b, 34a, 34b, 36a and 36b) can be attached along each isolated beam segment 30, 32, 34, and 36, respectively. The sensors 30a, 30b, 32a, 32b, 34a, 34b, 36a and 36b are configured to detect and measure a force applied to the force-sensing element 50. In addition, the sensors 30a, 30b, 32a, 32b, 34a, 34c, 36a and 36b are configured to output an electronic signal through a transmission device 40 attached or otherwise related to the sensors 30a, 30b, 32a, 32b, 34a, 34b, 36a and 36b, which signal corresponds to the applied force as detected by the sensors.

In one exemplary embodiment, the sensors 30a, 30b, 32a, 32b, 34a, 34c, 36a and 36b each comprise a strain gage configured to measure the strain within or across each of the respective isolated beam segments 30, 32, 34, and 36. Moreover, although each isolated beam segment 30, 32, 34, and 36 is shown comprising two sensors located or disposed thereon, the present invention is not limited to this configuration. It is contemplated that one, two or more than two sensors may be disposed along each of the isolated beam segments depending upon system constraints and other factors. In addition, it is contemplated that the sensors may be comprised of the beam segments themselves, if appropriately configured. The sensors are discussed in greater detail below.

The transmission device 40 is configured to carry the sensors' output signal to one or more signal processing devices, shown as signal processing device 44, wherein the signal processing devices function to process the signal in one or more ways for one or more purposes. For example, the signal processing devices may comprise analog signal processors, such as amplifiers, filters, and analog-to-digital converters. In addition, the signal processing devices may comprise a micro-computer processor that feeds the processed signal to a computer, as shown in FIG. 2. Or, the signal processing device may comprise the computer 48, itself. Still further, any combination of these and other types of signal processing devices may be incorporated and utilized. Typical signal processing devices are known in the art and are therefore not specifically described herein.

Processing means and methods employed by the signal processing device for processing the signal for one or more purposes, such as to determine the coordinates of a force applied to the force-based touch pad, are also known in the art. Various processing means and methods are discussed in further detail below.

With reference again to FIGS. 1 and 2, the base support 14 is shown comprising a substantially flat, or planar, pad or plate. The base support 14 can have an outer mounting surface 60 and an inner mounting surface 64 that can lie essentially within the same plane in a static condition. The outer mounting surface 60 can be located between the periphery 18 and the apertures 20, 22, 24, and 26. The inner mounting surface 64 can be located between the force-sensing element 50 and the apertures 20, 22, 24, and 26. The isolated beam segments 30, 32, 34, and 36 can connect the inner mounting surface 64 with the outer mounting surface 60. The outer mounting surface 60 can be mounted to any suitably stationary mounting structure configured to support the input device 10. The force-sensing element 50 can be a separate structure mounted to the inner mounting surface 64, or it may be configured to be an integral component that is formed integrally with the inner mounting surface 64. In the embodiment where the force-sensing element is a separate structure, one or more components of the force-sensing element can be configured to be removable from the inner mounting surface. For example, the force-sensing element 50 may comprise a large aperture formed in the base support 14, and a removable force panel configured to be inserted and supported within the aperture, which force panel functions to receive the applied force thereon from either direction.

The base support 14 can be formed of any material having suitable elastic properties, such as a metal, like aluminum or steel, or it can be formed of a suitably elastic, hardened polymer material, as is known in the art. In addition, the base support 14 may be formed of glass, ceramics, and other similar materials. The base support 14 can be shaped and configured to fit within any type of suitable interface application. For example, the base support can be configured as the viewing area of a display monitor, which is generally rectangular in shape. In addition, the base support 14 can be configured to be relatively thin so that the touch surface of the force-sensing element of the base support is only minimally offset from the viewing area of a display monitor, thereby minimizing distortion due to distance between the force-sensing element and the display monitor.

It is noted that the performance of the input device may be dependent upon the stiffness of the outer portion or outer mounting surface of the base support 14. As such, the base support 14, or at least appropriate portions thereof, should be made to comprise suitable rigidity or stiffness so as to enable the input device to function properly. Alternatively, instead of making the base support 14 stiff, the base support 14, or at least a suitable portion thereof, may be attached to some type of rigid support. Suitable rigidity functions to facilitate more accurate input readings.

The force-sensing element 50 can be a substantially flat, or planar, pad or plate and can lie within the same plane as the base support 14. The force-sensing element 50 can be circumscribed by the apertures 20, 22, 24, and 26.

The force-sensing element 50 is configured to displace in response to various stresses induced in the force-sensing element 50 resulting from application of a force, shown as arrow 54 in FIG. 2, acting on the force-sensing element 50. The force-sensing element 50 is further configured to transmit the stresses induced by the applied force 54 to the inner mounting surface 64 and eventually to the isolated beam segments 30, 32, 34, and 36 where resulting strains in the isolated beam segments are induced and measured by the one or more sensors.

The base support 14 and force-sensing element 50 can have a first side 80 and a second side 82. The present invention force-based input device 10 advantageously provides for the application of force to either the first or second sides 80 and 82 of the force-sensing element 50, and the force-sensing element 50 may be configured to displace out of the plane of the base support 14 in either direction in response to the applied force 54.

The force-sensing element 50 can be formed of any suitably rigid material that can transfer, or transmit the applied force 54. Such a material can be metal, glass, or a hardened polymer, as is known in the art.

The isolated beam segments 30, 32, 34, and 36 can be formed in the base support 14, and may be defined by the plurality of apertures 20, 22, 24, and 26. The isolated beam segments 30, 32, 34, and 36 can lie essentially in the same plane as the base support 14 and the force-sensing element 50 when in a static condition. In some embodiments, the apertures 20, 22, 24, and 26 may be configured to extend all the way through the base support 14. For example, the apertures 20, 22, 24, and 26 can be through slots or holes. In other embodiments, the isolated beam segments 30, 32, 34 and 36 may be configured to extend only partially through the base support 14.

As illustrated in FIG. 1, the isolated beam segment 32 can be formed or defined by the apertures 22 and 24. Aperture 22 can extend along a portion of the periphery 18 and have two ends 22a and 22b. The aperture 24 can extend along another portion of the periphery and have two ends 24a and 24b. Portions of the two apertures 22 and 24 can extend along a common portion of the periphery 18 where one end 22b of aperture 22 overlaps an end 24a of aperture 24. The two ends 22b and 24a, and the portions of the apertures 22 and 24 that extend along the common portion of the periphery 18, can be spaced apart on the base support 14 a pre-determined distance. The portion of the aperture 22 that extends along the common portion of the periphery 18 can be closer to the periphery 18 than portion of the aperture 24 that extends along the common portion of the periphery 18. The area of the base support 14 between the aperture 22 and the aperture 24, and between the end 22b and the end 24a, can define the isolated beam segment 32.

The isolated beam segments 30, 34, and 36 can be similarly formed and defined as described above for isolated beam segment 32. Isolated beam segment 30 can be formed by the area of the base support 14 between the apertures 24 and 20, and between the ends 24a and 20a. Isolated beam segment 34 can be formed by the area of the base support 14 between the apertures 24 and 26, and between the ends 24b and 26b. Isolated beam segment 36 can be formed by the area of the base support 14 between the apertures 26 and 20, and between the ends 26a and 20b. Thus, all of the isolated beam segments can be defined by the various apertures formed within the base support 14. In addition, the isolated beam segments may be configured to lie in the same plane as the plane of the force-sensing element 50 and base support 14, as noted above.

The plurality of apertures 20, 22, 24, and 26 can nest within each other, wherein apertures 22 and 26 extend along the sides 90 and 92 of the rectangular base support 14, and can turn perpendicular to the short sides 90 and 92 and extend along at least a portion of the sides 94 and 96 of the base support 14. Apertures 20 and 24 can be located along a portion of the sides 94 and 96 of the base support 14 and closer to the force-sensing element 50 than apertures 22 and 26. Thus, apertures 20 and 24 can be located or contained within apertures 22 and 26. Stated differently, the apertures may each comprise a segment that overlaps and runs parallel to a segment of another aperture to define an isolated beam segment, thus allowing the isolated beam segments to comprise any desired length.

In another exemplary embodiment similar to that shown in FIG. 1, the force-sensing element may be located about the perimeter or periphery of the input device with the inner and outer mounting surfaces being positioned inside or interior to the force-sensing element. In other words, the force-based input device may be considered to comprise a structural configuration that is the inverse of the configuration shown in FIG. 1. This further illustrates that the present invention broadly contemplates a first structural element supported in a fixed position, and a second structural element operable with the first structural element, wherein the second structural element is dynamically supported to be movable with respect to the first structural element to define a force-sensing element configured to displace under an applied force.

### Boundary Defining a Void

Referring again to FIG. 1, the force-based input device 10 is illustrated. As shown, the force-based input device 10 comprises a void 51 formed and present within the force-sensing element 50. Notably, the force-sensing element 50 may comprise a plurality of voids 51 of different size and location. The voids 51 may be distributed randomly about the surface of the force-sensing element 50 and/or they may be distributed in a pattern. The voids 51 may be bounded by a perimeter such as that shown at 51a and/or they may be partially bounded such as that shown in 51b. In one aspect of the invention, the boundary of the void 51 is determined by the intended user and/or purpose of the void 51. That is, if the void 51 is intended to receive a functional attachment (described in more detail below) its boundary may be defined differently than a void intended to serve an aesthetic purpose.

Notably, the voids 51 are formed within the force-sensing element 50 which itself is defined by the plurality of apertures or slots separating the force-sensing element 50 from the base support 14 and defining the plurality of isolated beam segments 30, 32, 34, and 36. The voids are essentially constrained or located within the force-sensing element 50, such that they are moveable with the movement or displacement of the force-sensing element. The voids are thus made to operate with the touch sensitive boundary established by the isolated beam segments.

Advantageously, these voids 51 do not disrupt the force-sensing capabilities of the force-based input device 10. In this manner, ornamental designs may be “cut out” of the force-sensing element 50 without impacting the force sensing capabilities of the force-sensing element 50. In like manner, the voids 51 enable user interaction with any number of functional attachments. Accordingly, the voids 51 can be configured to receive an external object (or objects) therein, including a functional attachment. In addition, the voids may be configured and intended to transmit physical material through the void, e.g., liquids (soda pop dispenser), solids (change dispenser), gasses (balloon inflator), etc.

In another example, the force-sensing element 50 can have any number and arrangements of holes or cut-out areas, to the point it could be a simple filigree design. That is, the entire force-sensing element 50 may comprise a two or three-dimensional design (not shown) with a plurality of voids 51 present throughout. Likewise, any functional attachment used in connection with the force-based input device 10 may also have any number and arrangement of holes or cut-out areas.

Advantageously, in one aspect of the invention, applying a force to the sensing surface of the force-sensing element 50, or the input surface of a functional attachment placed within a void 51, will operate the device and register a force just as if the force-sensing element 50 were a solid structure (presuming it remains reasonably rigid). That is, forces applied to a functional attachment (or other object within a void) may be transferred to the force-sensing element 50 through the attachment means which provide for attachment of the functional attachment to the input device 10. In addition, various voids 51 would allow operation of a device behind the void without registering a force or causing operation of the force-based input device 10. Examples of functional attachments which may be used in connection with the void 51 are discussed in more detail below.

It is understood and contemplated herein that voids 51 can be formed in the force-sensing element 50 or functional attachments for any number of purposes. For example, holes or cut-outs can be formed for the purpose of receiving screws or bolts that facilitate the coupling of various objects or items to the force-sensing element 50, for providing windows for displays, for facilitating operation of or access to sub-lying devices such as switches, adjustment potentiometers, etc. The voids 51 may be positioned with respect to a functional attachment to enable user interaction with the functional attachment. As part of this, the voids 51 may be configured for passage or transmittal of an object either to and/or from a functional attachment, including, for example, DVD's, CD's, credit/debit cards, money, or any other desirable object. Also, the voids 51 can be configured to receive an external object (or objects) therein, including a functional attachment. In some embodiments, the voids may be configured and intended to transmit physical material through the void, e.g., liquids (soda pop dispenser), solids (change dispenser), gasses (balloon inflator), etc.

Additionally, the voids may be configured to transmit wave energy such as sound and/or electromagnetic radiation. The wave energy may or may not be associated with functional attachments described in more detail below. Still further, the voids may be purely ornamental or aesthetic in purpose. In any event, the void 51 is configured to enhance user interaction with the input device 10 and/or devices that are used in connection with the input device 10.

As noted herein, any semi-rigid material may be used as a substrate for the force-sensing element 50. The voids 51 may be formed within the substrate by numerous means including milling, injection molding, drilling, or any other suitable method of forming a void within the substrate to provide a finished force-sensing element. Notably, the force-sensing element 50 does not need to be designed around a particular void. Rather, a void of any shape and/or design may be cut out of an existing substrate and immediately used as a force-sensing element 50. Additionally, holes may be drilled within an existing and operating force-sensing element 50 to install any type of attachment without affecting the operation of the force-sensing element 50.

### Functional Attachments

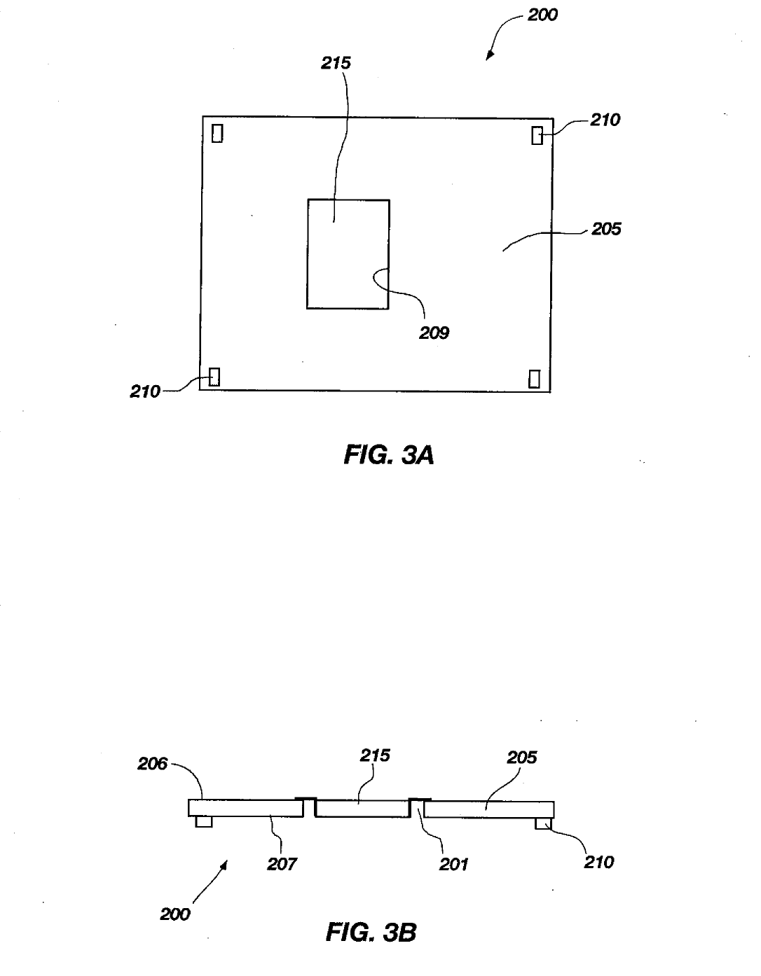

With reference to FIGS. 3-10, illustrated are force-based input devices in accordance with exemplary embodiments of the present invention. While multiple embodiments are shown herein, each on a respective force-based input device, it is understood that numerous functional attachments may be employed with numerous voids on a single force-based input device. Each functional attachment may operate independent of other functional attachments or they may function in tandem and/or cooperatively to perform a desired function. The voids noted above may be configured together with corresponding functional attachments such that the functional attachments may be interchangeable within the same void.

The force-based input device 200 comprises a force-sensing element 205 and a force sensor 210. The present invention force-based input device 200 may comprise many different functional attachments. These are made possible by the force-based technology of the input device, and particularly the technology described in FIGS. 1 and 2 and the above-referenced and incorporated application. However, the site and configuration of the force-sensing element, the number and placement locations of the force sensors, and the force-based input device in general, as shown, is not intended to be limiting in any way.

In the exemplary embodiment shown in FIGS. 3a and 3b, the display 215 comprises an LCD display that is supported within the force-sensing element 205, which has a void present in force-sensing element to house the display 215. Two things are of particular note here. First, the force-sensing element 205 is capable of having objects mounted directly to it without disrupting the force-sensing capabilities of the force-based input device. The display 215 is shown as being mounted within a void 201 of the force-sensing element 205. However, the force-sensing element 205 may also have objects mounted to a front surface 206 or a rear surface 207 of the force sensing element 205. In any event, being able to mount objects to the force-sensing element 205 provides many advantages, and allows the force-based input device to be much more functional and to provide many different user interfaces than prior related input devices.

In this case, the void is formed and configured to extend entirely through the force-sensing element. The void comprises, or is defined by a boundary 209, which boundary comprises a rectangular configuration. Because the void extends all the way through the force-sensing element, particularly as extending between the front surface 206 and rear surface 207, surfaces at the boundary are exposed, which surfaces are part of the force-sensing element. The display 215 may or may not come in contact with these surfaces. As discussed herein, the void is part of the force-sensing element configuration, having no affect on the performance of the force-sensing element in response to an applied force.

It is understood and contemplated herein that functional attachments may be mounted to the force-sensing element 205 using mounting means such as bolts, screws, etc., which can be removably attached or coupled to the force-sensing element 205. Removably coupling and supporting a functional attachment may be accomplished using any known means, such as an adhesive, a magnet, a hook and loop fastener, a snap or snap-like fastener, a zipper, and any others known in the art. Moreover, additional voids may be formed in the force-sensing element to receive and support the mounting means.

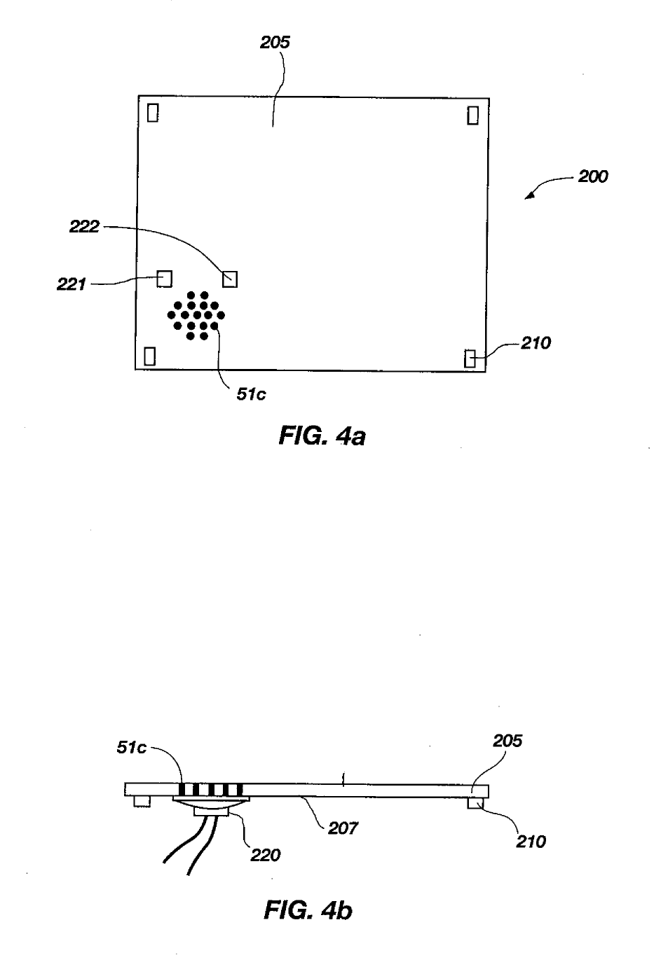

As shown on FIGS. 4a and 4b, the force-based input device 200 may further comprise a functional attachment in the form of a speaker 220. The speaker 220 is mounted to the rear surface 207 of the force-sensing element 205 and is not intended to be sensed by the force-sensing element 205. Voids 51c are present within the force-sensing element 205 for passage of sound waves from the speaker 220. It is also understood that the speaker 220 could mounted within a void formed in the force-sensing element 205, wherein the speaker housing is positioned about the force-sensing element to provide unobstructed sound wave propagation. Adjacent the speaker 220 are touch zones 221, 222 that are intended to control the volume of the speaker. These touch zones are part of the force-sensing element 205. Specifically, the force sensing element 205 comprises a touch zone 221 for adjusting the volume downward, and a touch zone 222 for adjusting the volume upward. Unlike the speaker 220, these touch zones 221 and 222 are intended to be sensed by the force-sensing element 205 to register a force. In addition, unlike the functional attachments that have input surfaces different from the force sensing element 205, which input surfaces receive an applied force, touch zones 221 and 222 are directly located on the force sensing element. Thus, adjustment of the volume of the speaker 220 upward or downward is accomplished by applying a force directly to the force sensing element 205 in the appropriate touch zone.

While not specifically shown, it is understood that volume control could be configured to be part of the speaker housing itself. In other words, by being disposed about the force-sensing element, the speaker becomes sensitive to touches, itself being capable of transferring a force to the force-sensing element detectable by the sensors. That is, forces applied to the speaker would be translated to the force-sensing element 205 through the means by which the speaker is mounted to the force-sensing element 205 (i.e., mounting bracket, screws, adhesive, etc.). Additionally, the speaker housing could be mounted within a void and configured such that a force applied to a right side, for example, of the speaker housing would register a force on the force-sensing element thereby increasing the volume of the speaker. In like manner, a force applied to a left side of the speaker housing would register a force thereby decreasing the volume of the speaker. Alternatively, the force-sensing element could be calibrated such that any forces emanating from the area proximate to the speaker housing were effectively “ignored” or not registered by the device.

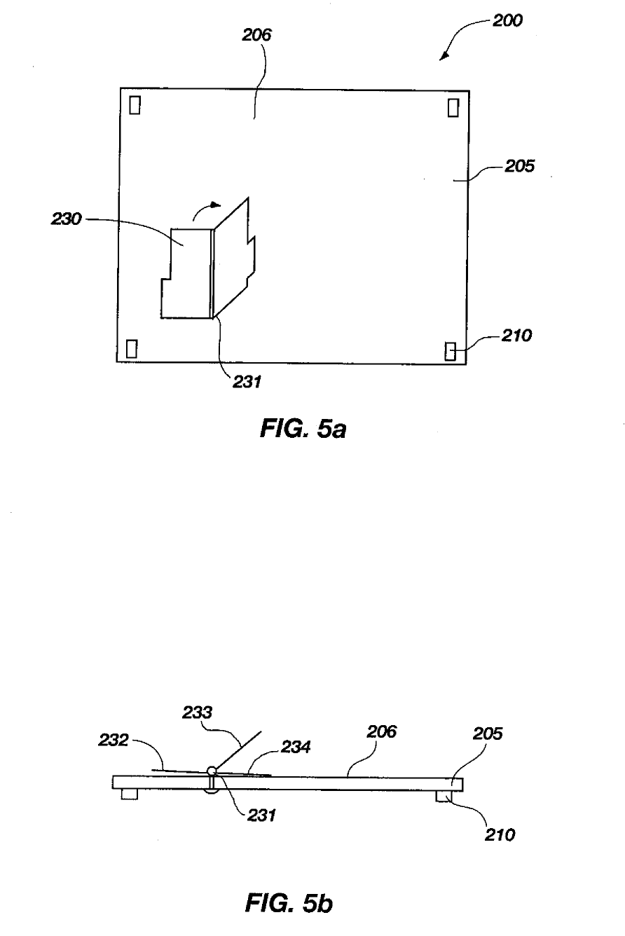

With reference now to FIGS. 5a and 5b, the force-based input device 200 may further comprise a multi-layered functional attachment 230 with zero to all of the different structural layers working with and intending to be sensed by the force-sensing element 205 upon application of a force thereto. In the exemplary embodiment shown, the force-based input device 200 comprises a multi-layered functional attachment 230 in the form of a mounted book-like structure. The multi-layered functional attachment 230 comprises multiple dynamic or movable leaves, each having at least one input surface with touch zones thereon, and each being coupled together via a hinge mechanism 231 that is mounted to the force-sensing element 205 via screws. The hinge mechanism 231 facilitates pivoting of each of the different leaves, shown as leaves 232, 233 and 234, about a common axis in order to expose different input surfaces. The three movable leaves provide eight total input surfaces for printed materials or other indicia. By pivoting the leaves 232, 233, and 234 about the hinge mechanism 231, much like turning the pages of a book, different input surfaces are exposed that will allow the user to perform different functions, access different information, control different objects, etc., depending on what the overall multi-layer functional attachment 230 is intended to do. Pivoting the leaves will also trigger a built-in detection means that functions to detect which leave is exposed to view. In one exemplary embodiment, detection means may comprise a cam mechanism as known in the art. Rotating the leaves to expose a different input surface to view will change the function of the touch zones from the previous input surface. Each of the leaves 232, 233, 234 comprises their own input surfaces. Selectively rotating these to view will activate the touch zones to perform the function intended upon applying forces to these particular input surfaces.

It is noted that although there are multiple layered structures, applied forces are still transmitted to the force-sensing element the same way as with a functional attachment having a single, non-layered input surface. Thus, applying a force to the input surface of any one of the structural layers 232, 233, 234 will effectively register a force about the same coordinates on the force-sensing element 205 as if the force were being applied directly to the force-sensing element 205. Some sensitivity may be lost the more layers the transfer of force is required to go through, but this may be accounted for in the software and by various other means to ensure accuracy. There is no limit to the number of layers through which applied forces can be sensed. However, the more layers there are, and the thicker they are, the less accurate may be the reported location.

The concept of providing multiple-layered functional attachments opens up even further the number of possibilities in providing user interfaces and functional objects about a force-based input device. For example, multiple-layer functional attachments may comprise booklet type designs where the leaves are opaque, and made of rigid (e.g., aluminum) or non-rigid (e.g., thin polycarbonate) material. The application software responding to the presses through the leaves would determine whether the device would need to sense when the pages are turned, or to which page they are turned. If the leaves pages have enough mass, the shifting of the static mass as the pages are turned could be detected via the force-sensing element. Otherwise, other methods such as mechanical switches and cams or LEDs and light sensors could be used to detect which input surface is open to view. Furthermore, knowing which input surface is open to view, either via shift mass, switches, etc., would allow for auto-calibration of the input device due to the shifting mass. If the leaves are made of a transparent material, they could also be flipped over a window portion behind which is a display. This could serve several purposes, such as color filters, blanking certain sections of the display, putting semi-dynamic labels over display items, and so on. The leaves do not necessarily need to be attached or mounted. For example, they can be stored elsewhere and inserted into a pocket or other mechanical alignment mechanism as needed. This would allow for interchangeable operator legends, either over an opaque surface, a light-providing surface (e.g., electroluminescent panel), or a display device providing additional dynamic information.

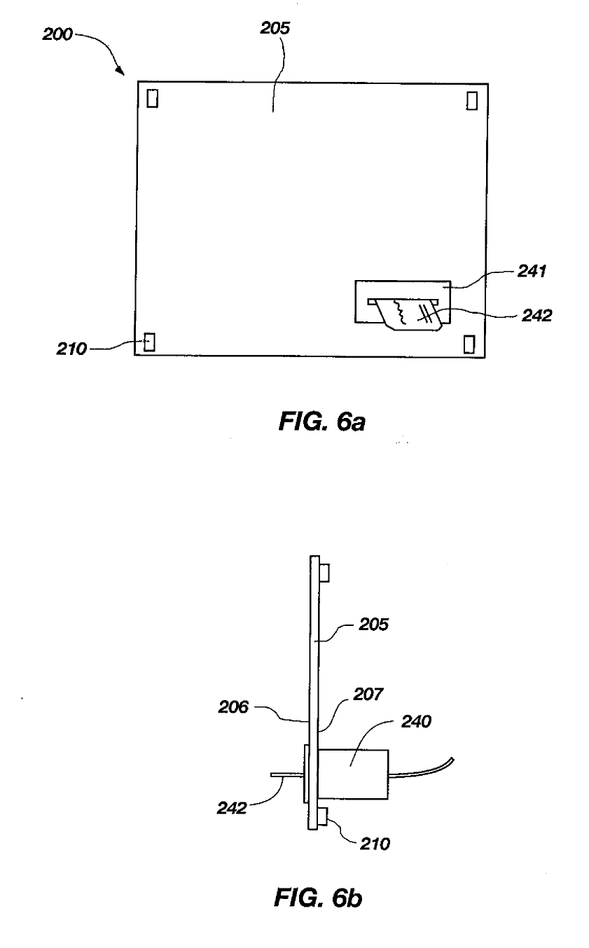

With reference now to FIGS. 6a and 6b, a force-based input device 200 is illustrated comprising a card reader 240 mounted within a void. A front surface 241 of the card reader 240 is disposed adjacent and parallel to a front surface 206 of the force-sensing element 205. As shown, a user may insert a card 242 into the card reader 240 with or without registering a force on the force-based input device 200. If a force is present and detected when the card is inserted, its location would tell the software it was due to card insertion and can be ignored. The card reader 240 may be operably connected to a computer or other information processing system which reads information from the inserted card 242.

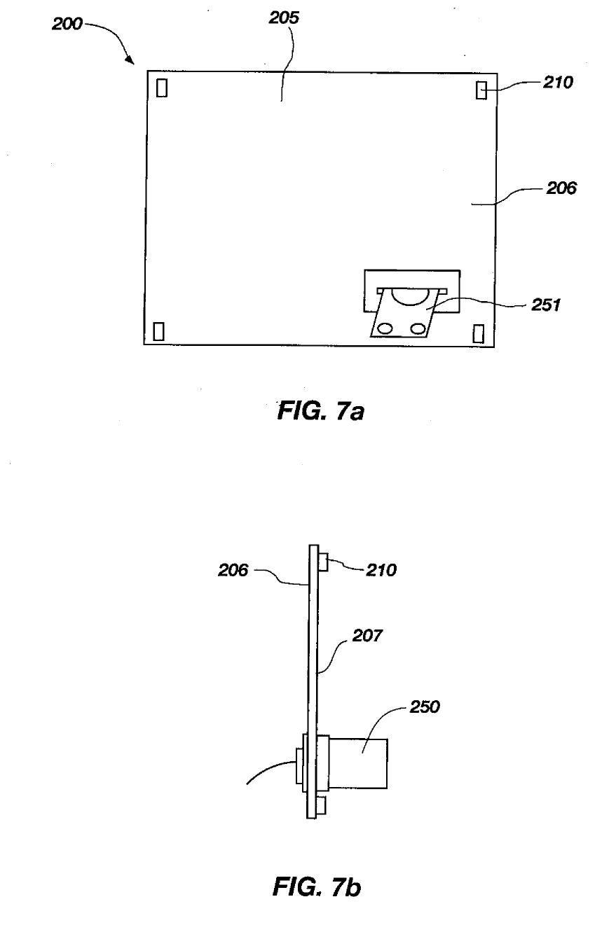

Shown in FIGS. 7a and 7b, in another aspect, a force-based input device 200 may comprise a device 250 configured to accept and/or dispense money 251. Such a functional attachment may be used for numerous purposes including vending machines, automatic teller machines, change machines, etc. Controls for vending and/or performing the various functions associated with this functional attachment could be designated in one or more control zones (not shown) on the force-sensing element.

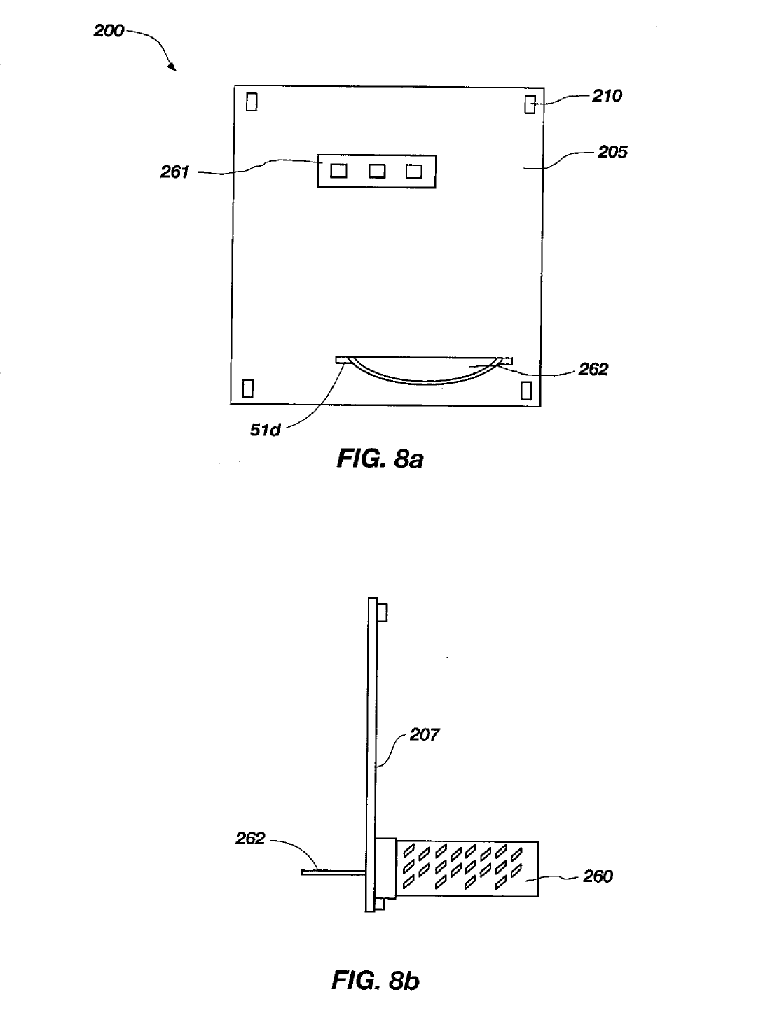

In yet another aspect, shown in FIGS. 8a and 8b, a DVD, CD, or other media player 260 may be mounted to a rear surface 207 of the force-based input device 200. As with many of the functional attachments described herein, the media player 260 may be operably connected to the force-based input device 200 such that management of the media player 260 is under the control of a user interface 261 on the force-based input device 200 (e.g., play, fast forward, stop, and eject functions). A void 51d present on the force-sensing element is configured to allow passage of the media 262 into and out of the media player 260.

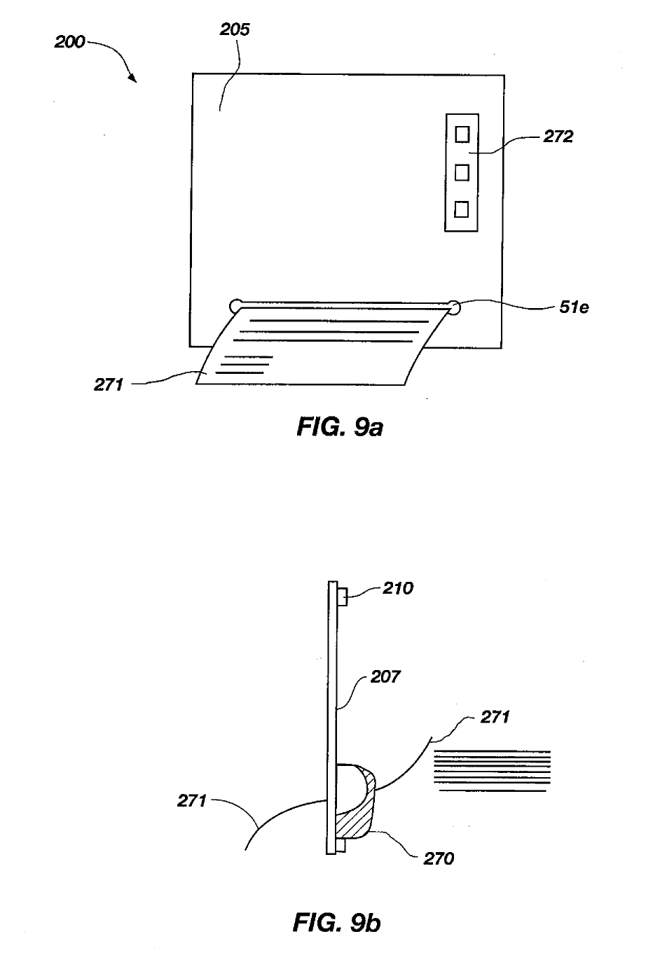

Illustrated in FIGS. 9a and 9b, in an additional aspect, a printer device 270 may be mounted to a rear surface 207 of the force-based input device 200. A void 51e is configured to act as a passage for printed material 271 coming from printer. As with other functional attachments noted herein, control of the printer may correspond to user inputs 272 on the force-based input device 200 (e.g., print, print preview, and menu options). While not shown, in an exemplary embodiment the LCD display of FIG. 3a could easily be mounted within a corresponding void and used in connection with the printer device 270 of FIGS. 9a and 9b.

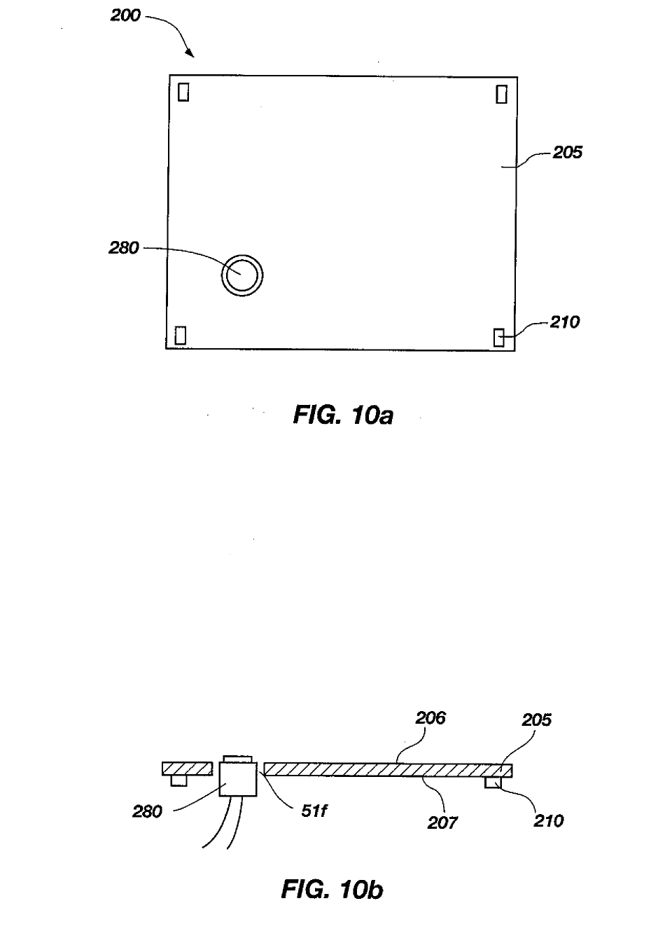

In an additional aspect, as shown in FIGS. 10a and 10b, a device as simple as a button 280 may be disposed within a void 51f. The button 280 may be operably connected to the force-input device 200 or some other device to render any desirable function.

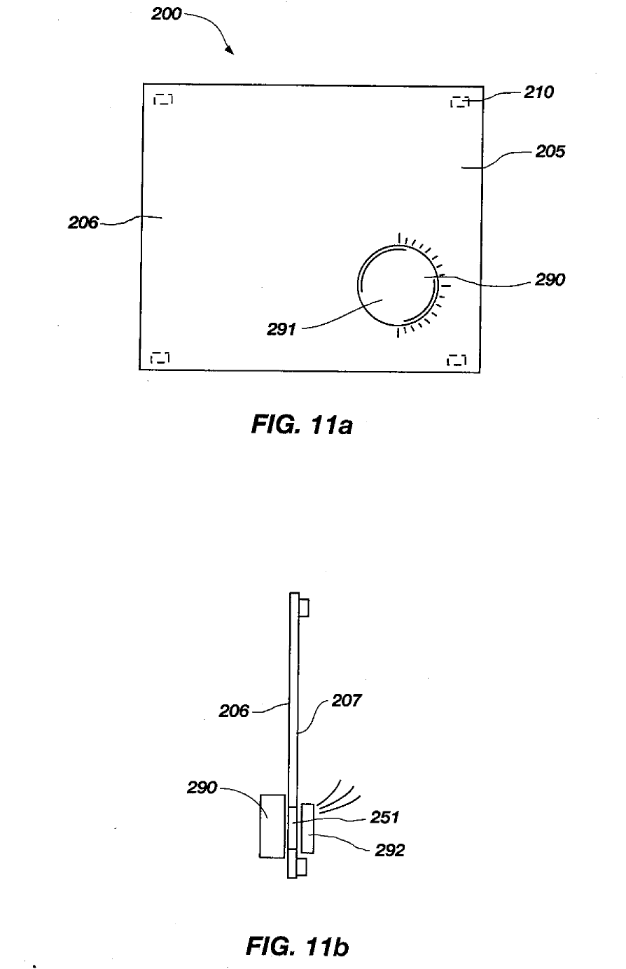

In yet another aspect, with reference now to FIGS. 11a and 11b a simple device such as a dial assembly 290 may be disposed within a void of an input device 200. The dial assembly 290 comprises a dial 291 mounted on a front surface 206 of the force-based input device 200, wherein the dial 291 is operably connected to a potentiometer 292 mounted on a rear surface 207 of the force-based input device.

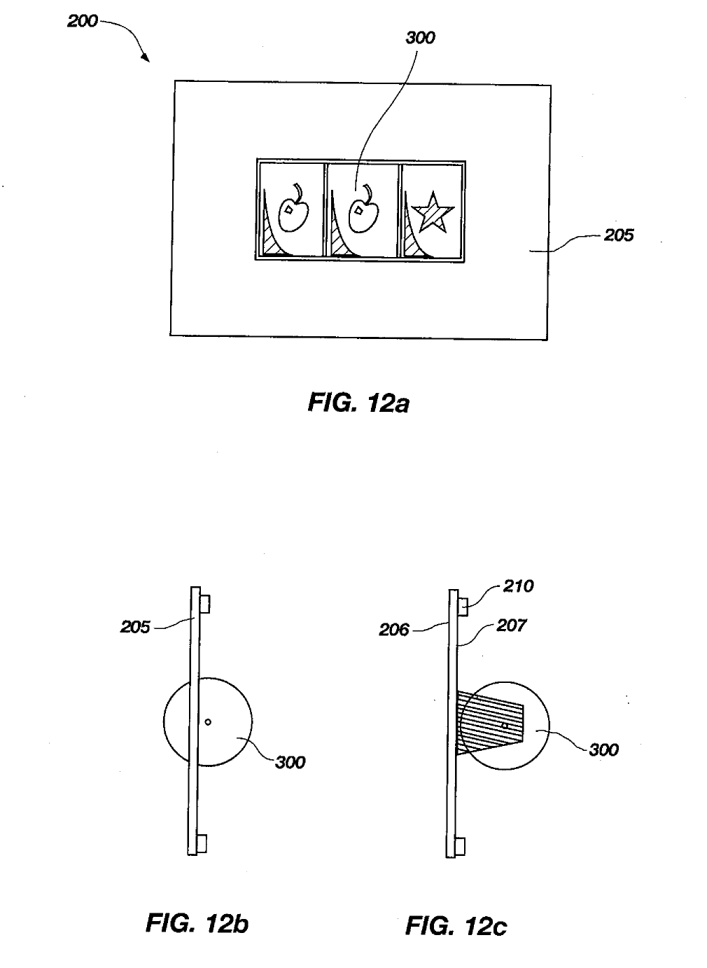

Additionally, in accordance with another embodiment of the present invention, as shown in FIGS. 12a, 12b, and 12c, a slot machine display 300 may be mounted on a force-based input device 200 and configured to rotate about its central axis in response to forces applied to the force-sensing element 205 which activate the slot machine display 300. The display 300 may be mounted on a rear surface of 207 of the force-sensing element 205 (see FIG. 12c) or it may be mounted within a void present within the force-sensing element 205 (see FIG. 12b) as desired for any particular application.

Other functional attachments may be utilized in connection with embodiments of the present invention which are not specifically shown and detailed herein. For example, but without limitation, a functional attachment may comprise a dynamic functional attachment having at least one moving element. Exemplary dynamic functional attachments are disclosed and claimed in more detail in United States patent application filed concurrently, and entitled “Force-Based Input Device with Dynamic Zero-Force Component” and assigned Attorney Docket No. 02089-32356.NP4.

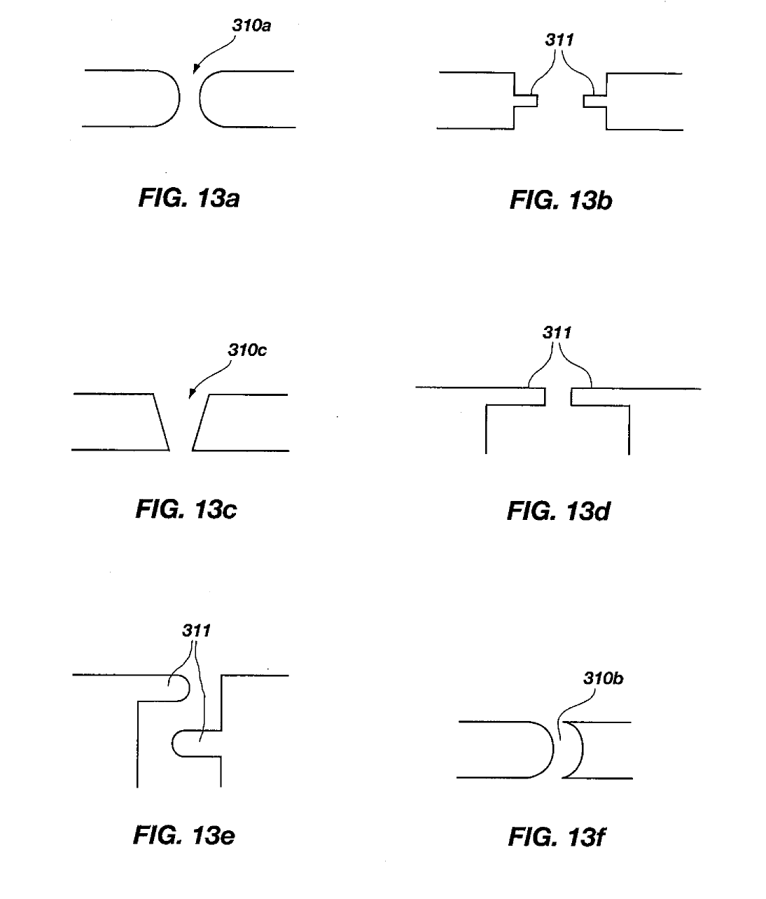

A common element of many of the foregoing functional attachments includes the capability to be housed within or provide interaction through a void present within a force-based input device 200. As described herein, the functional attachments may be operably connected to the force-based input device 200 to enhance the user interface capabilities of the force-based input device 200. Advantageously, the void does not have any negative impact on the ability of the force-based input device 200 to register a force and detect the location of that force while allowing placement and operation of said functional attachments. To that end, as discussed above, it is important to note that a number of configurations for any particular void are contemplated herein. For example, several partial side-views of multiple different embodiments of force-based input devices having voids formed therein are illustrated in FIGS. 13a through 13f. In one aspect, the void may be defined by one or more surfaces of the force-sensing element comprising a non-linear configuration. The non-linear surface configuration may be oriented in an opposing configuration 310a such as that shown on FIG. 13a or it may be oriented in a complementary configuration 310b such as that shown in FIG. 13f. In another aspect, the surface configuration defining the void may be oriented in a linear sloping configuration 310c as shown in FIG. 13c. In still another embodiment, the surface configuration defining the void may have opposing protrusions 311 as shown in exemplary configurations in FIGS. 13b, 13d, and 13e.

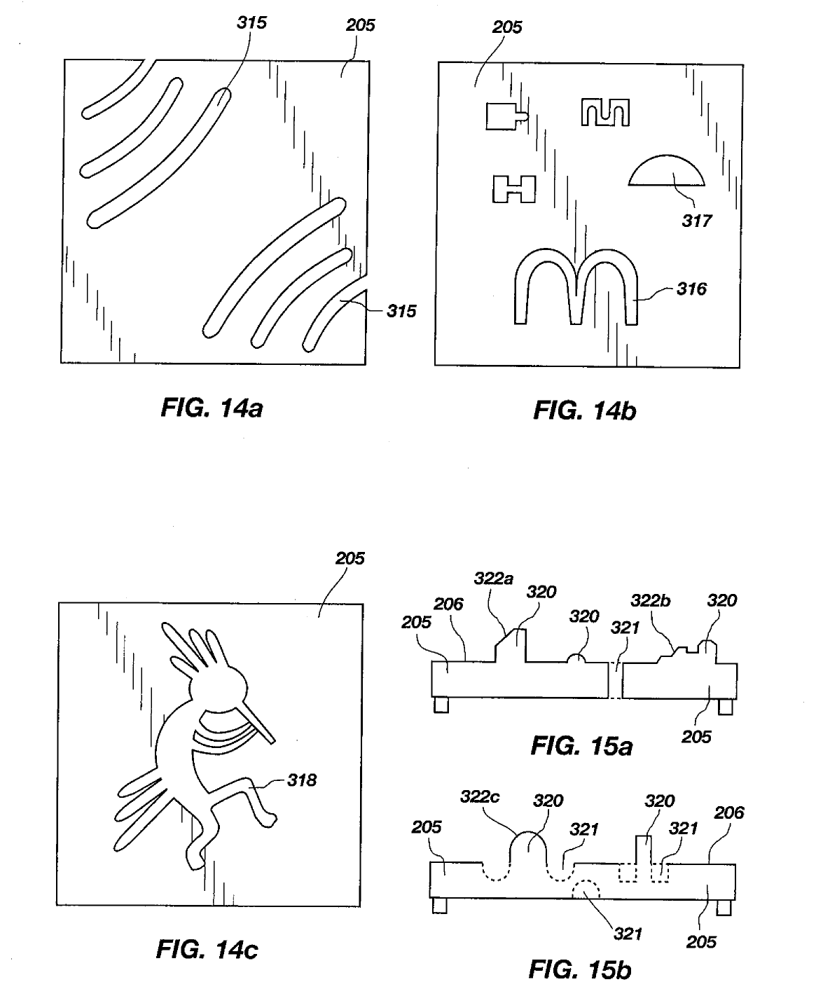

With reference to FIGS. 14a-14c, in accordance with an additional embodiment of the present invention, an input device 200 may comprise voids present within the force-sensing element in any two-dimensional configuration. For example, in one aspect shown in FIG. 14a, a plurality of spline voids 315 are formed and present within the force sensing element 205. In another aspect, shown in FIG. 14b, a plurality of randomly shaped voids are present and formed within the force-sensing element 205, including an arch-shaped void 316 and a semi-circle shaped void 317. In still another aspect shown in FIG. 14c, a void in the form of an artistic design 318 may be formed and present within the force-sensing element 205.

Referring now to FIGS. 15a and 15b, in accordance with one embodiment of the present invention, a force-based input device 200 is shown having a force-sensing element 205 comprising a three-dimensional surface 320 disposed on or integrally part of the force sensing element 205. The three-dimensional surface acts to transfer an applied force to force sensors associated with the force-sensing element 205 as with other applied forces described herein. As shown, voids 321 in the form of through holes or recesses may be present within the force-sensing element to help define and further enhance the three-dimensional surface 320. In one aspect of the invention, a force applied to any surface of the three-dimensional surface 320 may be registered on the force sensing element 205. This includes forces applied in a direction which is not normal to a front surface 206 of the force-sensing element 205. For example, a force applied on surface 322a, 322b, and/or 322c would still register a force on the force-sensing element 205 as the force has a normal force component acting on the force-sensing element 205. In general, most external forces applied to an object associated with the force-sensing element 205 are capable of being measured by the force-input device. Providing a force-sensing element with a three-dimensional layout greatly enhances available user interfaces particularly as these surfaces are made to be sensitive to applied forces, such that a force is registered.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A touch-based input device comprising:
a first structural element supported in a fixed position;
a second structural element operable with said first structural element and configured to define a touch-sensing element;
at least one sensor operable to measure an external stimulus applied to said touch-sensing element, the at least one sensor being configured to output a signal corresponding to said external stimulus to be used to determine a location of said external stimulus applied to said touch-sensing element; and
wherein at least a portion of the touch-sensing element comprises a boundary defining a void present in the touch-sensing element.

2. The touch-based input device of claim 1, wherein said void extends through the entire touch-sensing element.

3. The touch-based input device of claim 1, further comprising a functional attachment mounted to a surface of the touch-sensing element.

4. The touch-based input device of claim 3, wherein said functional attachment is mounted to a surface of the touch-sensing element such that a force exerted on the functional attachment displaces the touch-sensing element.

5. The touch-based input device of claim 3, wherein the functional attachment may be activated by displacement of the touch-sensing element.

6. A touch-based input device comprising:
a first structural element supported in a fixed position;
a second structural element operable with said first structural element and configured to define a touch-sensing element;
at least one sensor operable to measure an external stimulus applied to said touch-sensing element, the at least one sensor being configured to output a signal corresponding to said external stimulus to be used to determine a location of said external stimulus applied to said touch-sensing element; and
a void present within the touch-sensing element, said void configured such that operation of the touch sensing element is unaffected by the presence of said void.

7. The touch-based input device of claim 6, wherein said void is configured to transmit an external object or physical material therethrough.

8. The touch-based input device of claim 6, further comprising a functional attachment disposed within said void.

9. The touch-based input device of claim 6, wherein said functional attachment comprises a dynamic functional attachment having at least one moving element.

10. The touch-based input device of claim 6, wherein said functional attachment is removably supported within said void.

11. The touch-based input device of claim 6, wherein said functional attachment is interchangeable with another functional attachment.

12. The touch-based input device of claim 6, wherein said functional attachment is supported within said void using quick-release attachment means selected from the group consisting of a magnet, a hook and loop fastener, a snap or snap-like fastener, a zipper, an adhesive, and any combination of these.

13. The touch-based input device of claim 6, wherein said functional attachment is supported about said touch-sensing element using attachment means selected from the group consisting of a screw assembly, a bolt assembly, and any combination of these.

14. The touch-based input device of claim 6, wherein said functional attachment comprises multiple layers, each comprising an input surface, and each able to transfer an applied force to any lower layers of said functional attachment.

15. The touch-based input device of claim 6, wherein the void is positioned with respect to a functional attachment to enable user interaction with the functional attachment.

16. The touch-based input device of claim 15, wherein the user interaction comprises passage of an object to and/or from the functional attachment.

17. The touch-based input device of claim 15, wherein the void is configured to transmit wave energy.

18. The touch-based input device of claim 17, wherein the wave energy comprises sound, electromagnetic radiation, and any combination of these.

19. The touch-based input device of claim 6, wherein said touch-based input device is selected from a group consisting of a resistive-based input device, a capacitance-based input devices, a surface acoustic wave-based devices, a force-based input device, a infrared-based devices, and any combination of these.

20. The touch-based input device of claim 6, further comprising a functional attachment selected from the group consisting of a magnetic card reader, a DVD player, a USB port, a printer, a cash dispensing device, a button, a switch, a light, a speaker, a liquid dispensing unit, a change dispensing unit, and any combination of these.

21. The touch-based input device of claim 6, further comprising a plurality of voids disposed within said touch-sensing element.

22. The touch-based input device of claim 21, further comprising a plurality of functional attachments, each of the plurality of functional attachments disposed within one of the plurality of voids, each of said functional attachments operating independent of one another to perform one or more specified functions.

23. The touch-based input device of claim 6, further comprising a three-dimensional surface associated with the force-sensing element and configured to transfer an applied force to the at least one sensor.

24. The touch-based input device of claim 23, wherein said three-dimensional surface comprises at least one surface which is not parallel to a top surface of the force-sensing element.

25. A force-based input device comprising:
a first structural element supported in a fixed position;
a second structural element operable with said first structural element, and dynamically supported to be movable with respect to said first structural element to define a force-sensing element configured to displace under an applied force;
at least one sensor operable to measure a force resulting from said displacement of said force-sensing element, the at least one sensor being configured to output a signal corresponding to said measured force, to be used to determine a location of said applied force on said force-sensing element; and
at least one void present within the force-sensing element, said void configured such that operation of the touch sensing element is unaffected by the presence of said void.

26. The force-based input device of claim 25, further comprising a functional attachment disposed within said void and configured to operate without displacing the force-sensing element.

27. The force-based input device of claim 25, further comprising a functional attachment disposed within said void and configured such certain features of the functional attachment may be operated to displace the force-sensing element.

28. A force-based input device comprising:
a first structural element supported in a fixed position;
a second structural element operable with said first structural element, and dynamically supported to be movable with respect to said first structural element to define a force-sensing element configured to displace under an applied force;
a plurality of isolated beam segments joining said first and second structural elements, said isolated beam segments being operable to transfer forces between the first and second structural elements resulting from displacement of said force-sensing element;
at least one sensor operable to measure strain within each of said isolated beam segments resulting from said transfer of forces and said displacement of said force-sensing element, each of said sensors being configured to output a signal, corresponding to said applied force and said measured strain, to be used to determine a location of said applied force on said force-sensing element;
at least one void present within the force-sensing element; and
a functional attachment disposed within the at least one void.

29. A method for fabricating a force-based input device, comprising:
obtaining a substrate usable as a force-sensing element within said force-based input device;
forming one or more voids within said substrate to provide a finished force-sensing element, wherein the formation of said voids does not affect the operation of said substrate as a force-sensing element; and
configuring said substrate for placement of one or more sensors operable with said force-based input device.

30. The method of claim 29, wherein the step of forming one or more voids comprises removing portions of material from said substrate.

31. The method of claim 29, wherein the one or more voids is formed by a process selected from the group consisting of milling, injection molding, drilling, or any combination of these.
